(19) United States
(12) Patent Application Publication
(10) Pub. No.: US 2007/0019447 A1
(43) Pub. Date: Jan. 25, 2007

(54) Active resistors for reduction of transient power grid noise

(75) Inventors: Gokce Keskin, Pittsburgh, PA (US); Xin Li, Pittsburgh, PA (US); Lawrence Pileggi, Pittsburgh, PA (US)

Correspondence Address: MOORE & VAN ALLEN PLLC, P.O. BOX 13706, Research Triangle Park, NC, 27709, US

(73) Assignee: Carnegie Mellon University

(21) Appl. No.: 11/176,055

(22) Filed: Jul. 7, 2005

(51) Int. Cl. H02H 7/10

(52) U.S. Cl. 363/50

(57) ABSTRACT

Active resistors for reduction of transient power grid noise. An active resistance added in parallel to the operating circuit blocks of a semiconductor device. This resistance increases the damping ratio of the power grid, which in turn decreases the number and the magnitude of oscillations and/or noise resulting from step disturbances of the power supply current. The active resistance can implemented by a transistor connected to a bias voltage. Alternatively, the active resistance can be implemented by a drive transistor with a gain stage, or two active resistors where one responds to overshoots in the current flow and the second active resistor responds to droops in the current flow.

### BACKGROUND

Increasing transistor density in integrated circuits can increase overall performance, but at the cost of higher power consumption. A common approach to decrease the overall power consumption of such integrated circuit chips is to turn off the unused portions of the devices via clock gating, turning them on only when needed as determined by what the chip is actually doing at any particular time. The turning on and off of various sections of a semiconductor device results in sudden changes in the current demanded from the power supply for the device. A rapid change in power supply current can cause a power supply voltage drop (widely known as L.di/dt noise). A traditional approach for stabilizing the power supply voltage for such a device is to place decoupling capacitors on the board, package, and/or on the chip. The diminishing return of adding more capacitance and the exponential increase in the leakage of on-chip capacitors in advanced processes can make this solution expensive.

A substantial, often dominant component of power supply noise can result in a semiconductor device because the connections from the power supply to on-chip circuitry via the circuit board on which the device is mounted, via the package, and via rails on the inside of the chip all have parasitic inductance and capacitance. Thus, undesirable, transient oscillations can be caused by the resonances formed from the capacitances and inductances of the power grid. A model of the power grid for an integrated circuit is shown in FIG. 1. Inductances 102 are formed by the power feeds on the board on which the chip is mounted. Inductances 104 are present in the chip package, and inductances 106 are internal to the chip and result mostly from the supply rails to circuit elements 108. Capacitances 110 provide the capacitive contribution to any resonances.

### SUMMARY

Embodiments of the present invention include an active resistance added in parallel to the operating circuit blocks of a semiconductor device. This resistance increases the damping ratio of the power grid, which in turn decreases the number and the magnitude of oscillations and/or noise resulting from step disturbances of the power supply current. The active resistance would typically be integrated into the semiconductor device, but could be implemented separately. In at least some embodiments, the active resistance is implemented by a transistor connected to a bias voltage terminal so that it can be gated by a bias voltage. In operation, the transistor is biased to serve as a small signal resistance and provide power supply current damping. Alternatively, in some embodiments, the active resistor is implemented by one or more diode connected transistors.

In some embodiments, the active resistance can be implemented by a drive transistor and a gain stage having connectivity to a clock gating signal. In such an embodiment, the drive transistor can serve as a small signal resistance in accordance with a clock signal that turns on the relevant circuit block. Such an implementation allows the active resistor be turned off when not needed, further reducing power consumption. The gain stage can be implemented by a pair of PMOS transistors connected in parallel and a NMOS transistor connected to the power supply.

In some embodiments, the active resistance connected in parallel with the operating circuit block is a first active resistor. A second active resistor is further included, connected between the power supply terminal and a high supply voltage terminal. In such an embodiment, the first active resistor can respond to overshoots in the current flow and the second active resistor can respond to droops in the current flow. One or both of the active resistors in this embodiment can be implemented by a drive transistor with a gain stage.

### BRIEF DESCRIPTION OF THE DRAWINGS

FIG. 1 is a schematic representation of a power grid for a semiconductor device.

FIG. 2 is a schematic diagram that illustrates one embodiment of the present invention, as well as its method of operation.

FIG. 3 is a schematic diagram illustrating another example embodiment of the present invention.

FIG. 4 is schematic diagram illustrating yet another example embodiment of the present invention.

FIG. 5 illustrates an alternative embodiment of the active resistance of the present invention, wherein a bias voltage is not required for the active resistor. FIG. 5A and FIG. 5B illustrate embodiments with two types of transistors.

FIG. 6 illustrates another embodiment of a circuit, wherein a bias voltage is not required for the active resistors. FIG. 6A and FIG. 6B illustrate embodiments with two types of transistors.

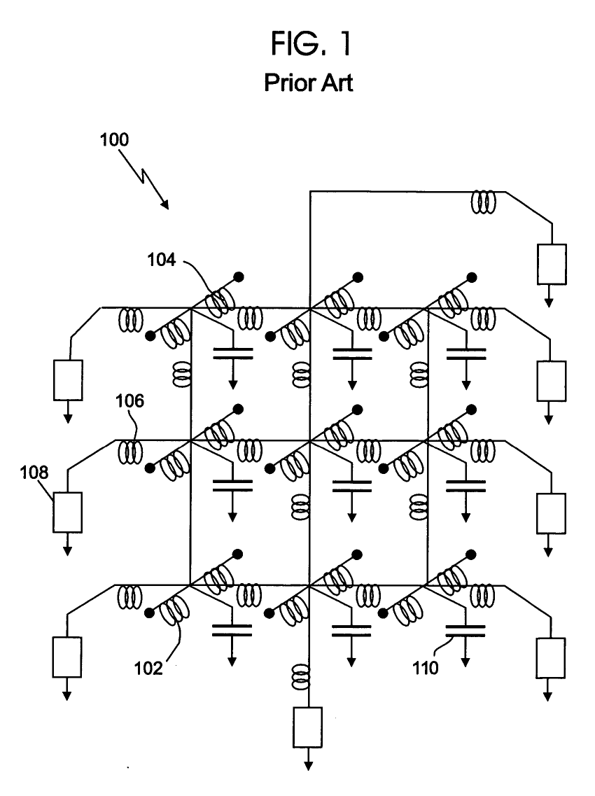

### DETAILED DESCRIPTION OF EXAMPLE EMBODIMENT(S)

The present invention will now be described in terms of specific, example embodiments. It is to be understood that the invention is not limited to the example embodiments disclosed. It should also be understood that not every feature of the devices or methods described is necessary to implement the invention as claimed in any particular one of the appended claims. Various elements and features of various embodiments of the invention are described in order to fully enable the invention. It should also be understood that throughout this disclosure, where a method is shown or described, the steps of the method may be performed in any order or simultaneously, unless it is clear from the context that one step depends on another being performed first.

References may be made throughout this disclosure to figures and descriptions using terms such as top, above, beneath, below, and other terms which imply a relative position of a structure or element. These terms are used merely for convenience and refer only to the relative position of features as shown from the perspective of the reader of this disclosure, and do not imply anything with respect to the structure of any physical devices or apparatus.

As previously mentioned, embodiments of the invention include the addition of an active resistance connected in parallel with operating circuit blocks of a semiconductor chip or device. An active resistance is a resistance that is based on one or more active devices and an active device is a device based on one or more elements that are capable of having gain. In some embodiments, the active resistance can be provided by a transistor operating as a small signal resistance because it is biased to operate in the small signal region. The active resistance, together with the operating circuit blocks, forms an apparatus in which power supply current is damped in the case of disturbances to current flow. Thus, it can be said that the power supply current is “actively damped” when an embodiment of the invention is employed.

Power supply current disturbances may originate from switching sections of a semiconductor device on and off. In at least some embodiments, the active resistance is a small signal resistance that increases the damping ratio of the overall power grid, which in turn decreases the number and magnitude of oscillations resulting from step disturbances of power supply current. The small signal active resistance of embodiments of the invention achieves increased effect when implemented on or within a semiconductor chip, since in such a case the resistance is positioned on the circuit side of inductive bonding connections of the chip package. However, an active resistance such as described herein can provide benefits even if installed on a circuit board external to a semiconductor device.

The damping effect of the active resistance of embodiments of the invention can be understood with reference to a formula for a critically damped system as shown below. If L is the approximation of the total parasitic inductance from the power supply to the region of interest in a semiconductor device, and C is the sum of the total parasitic capacitance between the rails and the added decoupling capacitance, then R indicates the resistance required to build a critically damped system. In a critically damped system, overshoot and undershoot in the supply voltage are substantially eliminated. Theoretically, the resistance can be lower than the value given by the equation, but a lower resistance would require extra power and chip area.

$$R = 0.5 \sqrt{\frac{L}{C}}$$

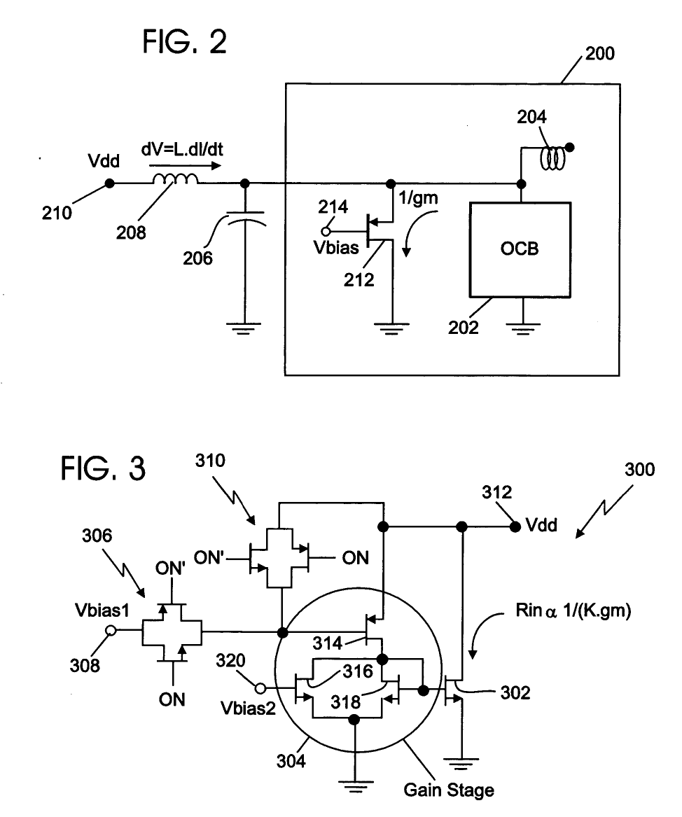

FIG. 2 presents a schematic diagram that illustrates at least one embodiment of the present invention. In FIG. 2, apparatus 200, a semiconductor device, includes an operating circuit block (OCB), 202. A portion of the power grid of the device is shown as inductance 204. Decoupling capacitor 206 is provided on the board (not shown) on which the semiconductor device is mounted. Inductance 208 represents the inductance caused by the power supply lead to the semiconductor device. The previously mentioned voltage drop (dV) caused by L.di/dt noise is shown at inductance 208. Power supply voltage Vdd is supplied at power supply terminal 210.

Still referring to FIG. 2, PMOS transistor 212 serves as an active resistance to provide the necessary damping in semiconductor device 200. Transistor 212 implements the resistance R from the previously discussed equation as a small signal resistance rather than a DC resistance. Implementing the active resistance as a small signal resistance prevents high DC power consumption while providing the required damping in the AC domain. Transistor 212 has its source connected to on-chip power, and its drain connected to on-chip ground. The gate of PMOS transistor 212 is connected to bias voltage terminal 214 to which a bias voltage, Vbias, is supplied. From the point of view of the power supply, this topology results in the transistor acting as a small signal resistance with the value of 1/gm, as indicated on FIG. 2, where gm is a small signal transconductance of the PMOS transistor.

Bias voltage for the circuit of FIG. 2, as well as other bias voltages discussed with respect to the embodiments shown herein, are determined so that AC input resistance of the circuit is low enough to achieve significant damping. The lower the resistance, the better for damping, however, if the resistance is too low, the power consumption of the active resistance increases. Thus, one of ordinary skill in the art can evaluate a trade off between power consumption and damping, and determine the appropriate bias voltage. One would choose the bias voltage so that power consumption can be kept at a reasonable level with significant damping being provided.

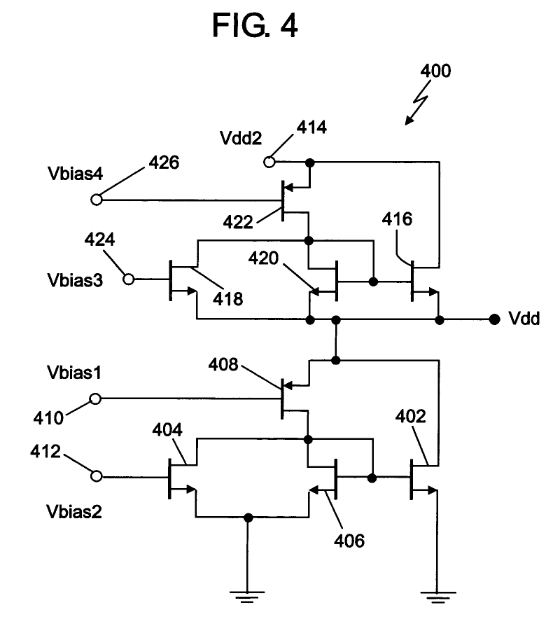

FIGS. 3 and 4 illustrate additional embodiments of the present invention. For clarity, only the active resistance portion of an apparatus in which the invention is implemented is illustrated in FIGS. 3 and 4. In the embodiments of FIGS. 3 and 4, better performance can be achieved with similar total power consumption due to providing a gain stage that enables the use of clock gating to turn the active resistances on only when needed; saving the power that would be consumed by the devices at other times. Turning to FIG. 3, active resistance circuit 300 includes NMOS drive transistor 302, and gain stage 304. One transmission gate circuit, 306, is connected to a bias voltage terminal, 308, in which a first bias voltage, Vbias1, is input. Another transmission gate circuit, 310, is connected to power supply terminal 312, which is also connected to supply voltage Vdd. Each transmission gate circuit is connected to clock gating signals. The “on” terminal for each transmission gate circuit is on when the clock gating signal is on, and the “on′ (on prime)” clock-gating signal is on when the clock gating signal is off. The clock-gating signal referred to is a standard signal provided in many semiconductor devices, especially, microprocessors. These gating signals determine whether a circuit block should be on or off at a particular time using a binary signal value. The active resistance circuit of FIG. 3 makes use of the gating signal to gate PMOS transistor 314, which is connected between parallel NMOS transistors 316 and 318, and the supply voltage terminal. Gain stage 304 is further supplied with an additional bias voltage, Vbias2, through bias voltage terminal 320.

In the circuit of FIG. 3, above, as well as the circuit discussed below with respect to FIG. 4, the drive transistor is connected in parallel with operating circuit blocks of interest. The clock-gating signal is the same signal which gates the parallel operating circuit block on and off. The input small signal resistance of the drive transistor in such implementations is then inversely proportional to the gain as shown by the formula below, wherein gm again represents the transconductance of the drive transistor. K is the gain of the gain stage. In the example of FIG. 3, K=1.
R∝1/(K·gm)

FIG. 4 illustrates another embodiment of the present invention. Circuit 400 of FIG. 4 includes, in the lower portion of the diagram, an active resistor made up of drive transistor 402 and a gain stage, similar to the gain stage shown in the circuit of FIG. 3. The gain stage for this active resistor, which is connected in parallel with the operating circuit blocks, is made up of NMOS transistors 404 and 406, and PMOS transistor 408. This active resistor circuit is shown having first and second bias voltage terminals, 410 and 412, respectively, to which two bias voltages, Vbias1 and Vbias2 are supplied. Circuit 400 of FIG. 4 however, also includes a high supply voltage terminal, 414, which is connected to higher supply voltage Vdd2. A second active resistor is connected between the normal power supply terminal and this second, higher power supply voltage terminal. The second active resistor includes transistor 416 operating as the drive transistor and a gain stage made up of transistors 418, 420, and 422. The second active resistor has two bias voltage terminals, 424 and 426. Third and fourth bias voltages, Vbias3 and Vbias4 are connected to bias voltage terminals 424 and 426.

Still referring to FIG. 4, the second higher power supply voltage, Vdd2, might be supplied by an input/output (I/O) power supply commonly found in integrated circuits. By placing the second active resistor between the two supply voltages, even better performance can be achieved relative to the circuits of FIGS. 2 and 3. The bias voltages can be adjusted so that the drive transistors are on the verge of conduction by setting their gate-to-source voltages to be close to their threshold voltages. Biasing the circuit in this way reduces the static power consumption of the active resistor circuits. In the topology of FIG. 4, the upper active resistor mainly responds to negative noise peaks or droops in the main supply voltage; whereas the lower active resistor mainly responds to positive peaks or overshoots in the main supply voltage.

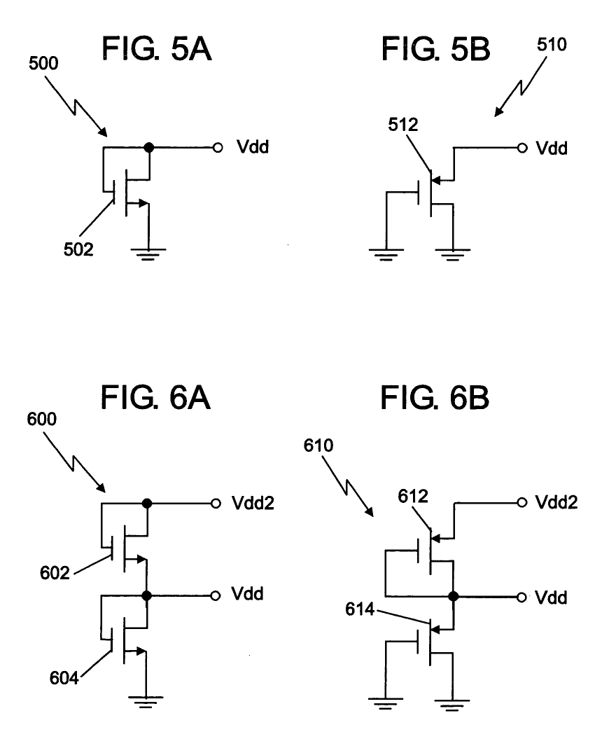

FIGS. 5 and 6 illustrate how an active resistance without a bias voltage can be used to implement embodiments of the invention. FIG. 5 illustrates an active resistor that can be used in embodiments where only a one supply voltage, Vdd, is used. In FIG. 5A active resistor 500 is implemented with NMOS transistor 502 but no bias voltage, since transistor 502 is connected in a diode configuration with its gate connected to Vdd. In FIG. 5B, active resistor 510 is implemented by diode connected PMOS transistor 512 configured so that its gate is connected to ground.

FIG. 6 illustrates the use of transistors operated in a diode configuration in a circuit which includes the high supply voltage Vdd2 as previously discussed. In FIG. 6A, an active resistance portion 600 of a circuit includes two NMOS transistors, 602 and 604, both diode configured. In FIG. 6B, an active resistance portion 610 of a circuit includes two PMOS transistors, 612 and 614, again both diode configured.

The previous example embodiments presented are just a few of many possible implementations of the present invention. Power grids provide the means for supplying current in many if not all analog, digital, and mixed signal integrated circuits. Many such circuits also employ gating to turn circuit blocks on and off, and one of skill in the art can design such a circuit to include active resistance either with or without gating according to an embodiment of the invention in order to dampen noise and oscillations in supply current. Adjustments can be made to the biasing of the active resistor circuits and the size of the included transistors to adapt an embodiment of the invention to a circuit as needed. It should also be noted that multiple active resistances can be connected in parallel to improve performance with any of the topologies presented thus far, as well as with other topologies.

Specific embodiments of an invention have been herein described. One of ordinary skill in the circuit design arts will quickly recognize that the invention has numerous other embodiments. The following claims are in no way intended to limit the scope of the invention to the specific embodiments described.

1. Apparatus comprising:
at least one operating circuit block connected to a power supply terminal; and
an active resistance connected in parallel with the operating circuit block to provide power supply current damping in case of disturbance of current flow to the at least one operating circuit block.

2. The apparatus of claim 1 wherein the active resistance further comprises a transistor connected to a bias voltage terminal so that it can be biased by a bias voltage so that the transistor can serve as a small signal resistance.

3. The apparatus of claim 1 wherein the active resistance further comprises:
a drive transistor connected in parallel with the at least one operating circuit block;
connectivity to a clock gating signal; and
a gain stage connected to the first and second transmission gate circuits and the drive transistor so that the drive transistor can serve as a small signal resistance in accordance with a clock signal.

4. The apparatus of claim 3 wherein the gain stage further comprises:
a pair of NMOS transistors connected in parallel; and
an PMOS transistor connected between the pair of NMOS transistors and the power supply terminal.

5. The apparatus of claim 1 wherein:
the active resistance further comprises a first active resistor connected in parallel with the at least one operating circuit; and
the apparatus further comprises a second active resistor connected between the power supply terminal and a high supply voltage terminal so that the first active resistor can respond to overshoots in the current flow and the second active resistor can respond to droops in the current flow.

6. The apparatus of claim 5 wherein at least one of the first and second active resistors further comprise:
a drive transistor; and
a gain stage connected to the power supply terminal, a bias voltage terminal and the drive transistor so that the drive transistor can serve as a small signal resistance.

7. The apparatus of claim 1 wherein the active resistor further comprises a diode connected transistor.

8. The apparatus of claim 5 wherein at least one of the first active resistor and the second active resistor further comprises a diode connected transistor.

9. The apparatus of claim 1 wherein the apparatus is a semiconductor device.

10. The apparatus of claim 2 wherein the apparatus is a semiconductor device.

11. The apparatus of claim 3 wherein the apparatus is a semiconductor device.

12. The apparatus of claim 5 wherein the apparatus is a semiconductor device.

13. The apparatus of claim 7 wherein the apparatus is a semiconductor device.

14. The apparatus of claim 8 wherein the apparatus is a semiconductor device.

15. A method of operating a semiconductor device comprising:
operating a plurality of circuit blocks to cause a step disturbance in power supply current; and
biasing an active resistance to serve as a small signal resistance and provide power supply current damping to reduce the step disturbance in the power supply current.

16. The method of claim 15 wherein the biasing of the active resistance is accomplished in anticipation of a clock signal.

17. Apparatus comprising:
at least one operating circuit block;
means for supplying power to the at least one operating circuit block; and
means for actively damping a power supply current in the means for supplying power in case of disturbance of current flow to the at least one operating circuit block.

18. The apparatus of claim 17 further comprising means for biasing the means for actively damping so that the means for actively damping can act as a small signal resistance.

19. The apparatus of claim 18 further comprising:
means for causing the means for actively damping to act as the small signal resistance in accordance with a clock signal; and
means for connecting the means for causing to a clock gating signal.

20. The apparatus of claim 17 wherein the means for actively damping further comprises:
means for responding to overshoots in current flow; and
means for responding to droops in current flow.
